(19) United States
(12) Patent Application Publication
(10) Pub. No.: US 2021/0371561 A1
(43) Pub. Date: Dec. 2, 2021

(54) FLUOROCOPOLYMERS FOR COATING APPLICATIONS

(71) Applicant: HONEYWELL INTERNATIONAL INC., Charlotte, NC (US)

(72) Inventors: Gang XU, Charlotte, NC (US); Min JIAN, Charlotte, NC (US); Siyuan ZHANG, Charlotte, NC (US); Linlin DUAN, Charlotte, NC (US)

(21) Appl. No.: 17/277,977

(22) PCT Filed: Sep. 19, 2018
(86) PCT No.: PCT/CN2018/106519

§ 371 Date: Mar. 19, 2021

(51) Int. Cl. C08F 214/18; C09D 127/12

(52) U.S. Cl. CPC C08F 214/188; C09D 127/12

(57) ABSTRACT

Disclosed are copolymers formed by copolymerization of: (1) one or more hydrofluoroolefin monomer(s) such as hydrofluoropropenes, (2) one or more of an alkyl vinyl ether monomer(s) that are not substituted with a reactive group, and (3) one or more reactive group substituted, lower alkyl vinyl ether monomer(s) wherein the copolymer has a MWn of from about 1000 to about 6000 grams/mole and other advantageous properties.

### FIELD OF THE INVENTION

The present invention relates to novel fluorocopolymers, and to low viscosity/high solids content coating compositions, each of which exhibits a difficult to achieve combination of important properties, including excellent adhesion to substrates (especially compared to copolymers formed from fluoroethylene/vinylether (commonly referred to as FEVE resins), high resistance to weathering/corrosion, good flexibility and mechanical properties, high gloss, ease of use and application and environmental friendliness. The present invention also relates to methods of reducing the exposure of earth's atmosphere to volatile organic compounds (VOCs) while forming protective coatings on substrates.

### BACKGROUND OF THE INVENTION

It has been known to use compositions based on polyvinylidene fluoride (PVDF) in high performance coating applications. For example, U.S. Pat. Nos. 8,093,329 and 7,399,533 disclose PVDF polymer resins and indicates that such resins provide good solvent resistance, chemical resistance, weather resistance, heat stability, strength and resilience. These coatings are based on non-aqueous dispersions of solid PVDF particles in an organic solution of acrylic polymers. The patents indicate that after baking the coating above the PVDF melting temperature, a homogenous blend of PVDF and acrylic phase is formed, which is said to provide the coating with durability and other properties such as gloss, adhesion, solvent resistance, and weatherability. However, the patent indicates that the coatings are

PVDF solvent-base coatings (e.g. KYNAR 500®) have been usually used on metal substrates. PVDF combined with acrylic polymer additive for use in water-based coatings which can be applied on variety of substrates such as metal or ceramic surfaces, and in the impregnation of textiles, glass, carbon or aramid fibers. Although this patent indicates that such coatings A large number of possible monomers are identified for use in fluoropolymer portion of the coating composition. , imonVolatile organic compounds (VOCs) are volatile compounds of carbon that are subject to regulation by various government authorities, and for the purposes of the present invention the term is used consistent with proposed regulations established by the United States Environmental Protection Agency (EPA). More specifically, these proposed regulations establish that a compound of carbon is a VOC if it has a vapor pressure of less than about 0.1 millimeters of mercury at 20° C.

A variety of chemicals are within the definition of VOC, and some of these chemicals have short- and long-term adverse health effects when released into the atmosphere. Accordingly, many countries have regulations governing the release of such compounds into the earth's atmosphere. One relatively large source of release of such compounds into the environment has been from the solvents that are used in coating products such as, paints, varnishes, waxes, adhesives, inks and the like. Many cleaning, disinfecting, cosmetic, degreasing, and hobby products also contain VOCs as solvents or carriers. One method to reduce or eliminate the release of such compounds into the atmosphere is to capture and prevent release of the solvent as it evaporates from the coating composition. Such methods can involve, for example, the installation of a mechanism to capture the vapors and to process such vapors in an incinerator. However, as will be appreciated to those skilled in the art a substantial capital cost and/or processing cost is incurred as a result of such operations, and such operations can sometimes add detrimentally to the time required to complete such coating operations.

In order to reduce and control the VOC emission into the earth's atmosphere, more and more countries have started to regulate VOC emissions. Such regulations include in various countries charging a VOC tax upon release of such compounds. Accordingly, there are many incentives to reduce the release of VOCs into the atmosphere.

### SUMMARY OF THE INVENTION

One aspect of the present invention provides fluorocopolymers formed by copolymerization of:
(1) one or more hydrofluoroolefin monomer(s), preferably in an amount of from about 40 mole % to about 70 mole % based on all of the monomers in the copolymer, and preferably selected from the group consisting of hydrofluoroethylenes, hydrofluoropropenes, hydrofluorobutenes, hydrofluoropentenes and combinations of these, and preferably selected from 2,3,3,3-tetrafluoropropene and 1,3,3,3-tetrafluoropropene, with said 1,3,3,3-tetrafluoropropene preferably comprising, consisting essentially of or consisting of trans-1,3,3,3-tetrafluoropropene,
(2) one or more of an alkyl vinyl ether monomer(s) (and preferably lower alkyl vinyl ethers) that are not substituted with a reactive group, preferably in an amount of from about 20 mole % to about 40 mole % weight based on all of the monomers in the copolymer,
(3) one or more reactive group substituted, preferably hydroxyl substituted, lower alkyl vinyl ether monomer(s) (and preferably lower alkyl vinyl ethers), preferably in an amount of from about 5 mole % to about 20 mole % based on all of the monomers in the copolymer, and
(4) optionally one or more of an alkyl vinyl ester monomer, preferably in an amount of from 0 mole % but not greater than about 20 mole % based on all of the monomers in the copolymer,
   wherein the copolymer has a MWn of from about 1000 to about 6000 grams/mole.

As used herein, the term “copolymer” means polymers having two or more different repeating units, and the term “fluorocopolymer” means copolymers in which at least one of the repeating units is based on a monomer that is a hydrofluoroolefin. The term “terpolymer” means polymers having three or more different repeating units, and the term “terfluorocopolymer” means terpolymers in which at least one of the repeating units is based on a monomer that is a hydrofluoroolefin. The term “tetrapolymer” is intended to include oligomers and copolymers having four or more different repeating units, and the term “tetrafluorocopolymer” means tetrapolymers in which at least one of the repeating units is based on a monomer that is a hydrofluoroolefin. Thus, a tetrapolymer derived from monomers A, B, C and D has repeating units (-A-), (-B-), (-C-) and (-D-), and a tetrafluorocopolymer derived from monomers A, B, C and D wherein at least one of these is a hydrofluoroolefin.

As used herein, the term “lower alkyl vinyl ether” refers to compounds having the following structure:
R—O—C═CH₂,
   where R is a alkyl group having from 1 to 6 carbon atoms.

As used s used herein, the term “reactive group lower alkyl vinyl ether” refers to compounds having the following structure:
Rs—O—C═CH2,
where Rs is a alkyl group having from 1 to 6 carbon atoms having at least one reactive group substituent seleceted from hydroxyl groups, carboxyl groups and epoxy groups.

The repeating units according to the present invention can be arranged in any form, including as alternating copolymers, as periodic copolymers, statistical copolymers, block copolymers and graft copolymers.

According to certain preferred embodiments, the present invention provides terfluorocopolymers, and preferably tetrafluorcopolymers, formed by copolymerization of a mixture containing a combination of monomers, said monomer combination consisting essentially of:
(1) fluoroolefin monomers consisting essentially of trans-1,3,3,3-tetrafluoropropene monomer and/or 1,3,3,3-tetrafluoropropene monomer;
(2) one or more lower alkyl vinyl ether monomers that are not substituted with a reactive group; and
(3) one or more reactive group substituted, preferably hydroxyl substituted, lower alkyl vinyl ether monomer(s),
   wherein terfluorocopolymer has a number average molecular weight of from about 1,000 to about 6,000 and a hydroxyl value of from about 50 to about 150.

According to certain preferred embodiments, the present invention provides terfluorocopolymers, and preferably tetrafluorcopolymers, formed by copolymerization of a mixture containing a combination of monomers, said monomer combination consisting essentially of:
(1) fluoroolefin monomers consisting essentially of trans-1,3,3,3-tetrafluoropropene monomer and/or 1,3,3,3-tetrafluoropropene monomer;
(2) one or more lower alkyl vinyl ether monomers that are not substituted with a reactive group; and
(3) one or more reactive group substituted, preferably hydroxyl substituted, lower alkyl vinyl ether monomer(s),
   wherein terfluorocopolymer: (i) has a number average molecular weight of from about 1,000 to about 6,000: (2) a hydroxyl value of from about 50 to about 150; and (3) a low viscosity at high solids content, preferably a viscosity of from about 4000 mPas to about 12000 mPas at an 80% solids content in butyl acetate.

One aspect of the present invention provides fluorocopolymers formed by copolymerization of:
(1) one or more hydrofluoroolefin monomer(s), preferably in an amount of from about 40 mole % to about 70 mole % based on all of the monomers in the copolymer, and preferably selected from the group consisting of hydrofluoroethylenes, hydrofluoropropenes, hydrofluorobutenes, hydrofluoropentenes and combinations of these, and preferably selected from 2,3,3,3-tetrafluoropropene and 1,3,3,3-tetrafluoropropene, with said 1,3,3,3-tetrafluoropropene preferably comprising, consisting essentially of or consisting of trans-1,3,3,3-tetrafluoropropene,
(2) one or more of an alkyl vinyl ether monomer(s) (and preferably lower alkyl vinyl ethers) that are not substituted with a reactive group, preferably in an amount of from about 20 mole % to about 40 mole % weight based on all of the monomers in the copolymer,
(3) one or more reactive group substituted, preferably hydroxyl substituted, lower alkyl vinyl ether monomer(s) (and preferably lower alkyl vinyl ethers), preferably in an amount of from about 5 mole % to about 20 mole % based on all of the monomers in the copolymer, and
(4) optionally one or more of an alkyl vinyl ester monomer, preferably in an amount of from 0 mole % but not greater than about 20 mole % based on all of the monomers in the copolymer,
   wherein the copolymer has (i) has a number average molecular weight of from about 1,000 to about 6,000: (2) a hydroxyl value of from about 50 to about 150; and (3) a low viscosity at high solids content, preferably a viscosity of from about 4000 mPas to about 12000 mPas at an 80% solids content in butyl acetate a MWn of from about 1000 to about 6000 grams/mole.

According to preferred aspects, the present invention provides tetrafluorocopolymers as described in the previous paragraph wherein the polymer has a number average molecular weight of about 1000 to about 6000, more preferably about 3500 to about 5000, and preferably in other embodiments of about 4500.

According to preferred aspects, the present invention provides tetrafluorocopolymers as described in the previous paragraph wherein the polymer has an Mw/Mn of from about 1 to about 3, more preferably about 1 to about 2.

According to preferred aspects, the present invention provides tetrafluorocopolymers as described in the previous paragraph wherein the polymer has a hydroxyl value of number average molecular weight of greater from about 50 to about 150 mgKOH/g, more preferably about 50 to about 100.

One aspect of the present invention provides methods of coating a substrate with a protective coating comprising:
(a) providing a substrate, preferably a substrate comprising metal, to be coated;
(b) providing a coating composition which is formed by steps comprising:
   (i) providing one or more fluorocopolymers by copolymerization of:
      (A) one or more hydrofluoroolefin monomer(s), preferably in an amount of from about 40 mole % to about 70 mole % based on all of the monomers in the copolymer and preferably selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these,
      (B) one or more reactive group substituted, preferably hydroxyl substituted, lower alkyl vinyl ether monomer(s) (and preferably lower alkyl vinyl ethers), preferably in an amount of from about 5 mole % to about 20 mole % based on all of the monomers in the copolymer, and
      (C) one or more of an alkyl vinyl ether monomer(s) (and preferably lower alkyl vinyl ethers) that are not substituted with a reactive group, preferably in an amount of from about 20 mole % to about 40 mole % weight based on all of the monomers in the copolymer, and
      (D) optionally one or more of an alkyl vinyl ester monomer, preferably in an amount of from 0 mole % to about 20 mole % based on all of the monomers in the copolymer,
         wherein the copolymer has a MWn of from about 1000 to about 6000 grams/mole,
   (ii) providing a carrier for said one or more fluorocopolymers; and
   (iii) combining said one or more fluorocopolymers with said carrier to produce a polymeric composition comprising not greater than about 30% by weight of said carrier and a solids content of at least about 70% by weight and a viscosity of from about 4000 to about 12000 mPas;
(c) coating the substrate with said coating composition; and
(d) forming a protective polymeric layer on said substrate by allowing at least a substantial portion of said carrier to evaporate, whereby said protective coating is formed.

One aspect of the present invention provides methods of coating a substrate with a high gloss protective coating comprising:
(a) providing a substrate, preferably a substrate comprising metal, to be coated;
(b) providing a coating composition which is formed by steps comprising:
   (i) providing one or more fluorocopolymers by copolymerization of:
      (A) one or more hydrofluoroolefin monomer(s), preferably in an amount of from about 40 mole % to about 70 mole % based on all of the monomers in the copolymer and preferably selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these,
      (B) one or more reactive group substituted, preferably hydroxyl substituted, lower alkyl vinyl ether monomer(s) (and preferably lower alkyl vinyl ethers), preferably in an amount of from about 5 mole % to about 20 mole % based on all of the monomers in the copolymer, and
      (C) one or more of an alkyl vinyl ether monomer(s) (and preferably lower alkyl vinyl ethers) that are not substituted with a reactive group, preferably in an amount of from about 20 mole % to about 40 mole % weight based on all of the monomers in the copolymer, and
      (D) optionally one or more of an alkyl vinyl ester monomer, preferably in an amount of from 0 mole % to about 20 mole % based on all of the monomers in the copolymer,
         wherein the copolymer has a MWn of from about 1000 to about 6000 grams/mole,
   (ii) providing a carrier for said one or more fluorocopolymers; and
   (iii) combining said one or more fluorocopolymers with said carrier to produce a polymeric composition comprising not greater than about 30% by weight of said carrier and a solids content of at least about 70% by weight;
(c) coating the substrate with said coating composition; and
(d) forming a protective polymeric layer on said substrate by allowing at least a substantial portion of said carrier to evaporate, whereby a protective coating having a 60° gloss of at least about 55, more preferably at least about 60 and even more preferably at least about 70.

One aspect of the present invention provides methods of coating a substrate with a high gloss protective coating comprising:
(a) providing a substrate, preferably a substrate comprising metal, to be coated;
(b) providing a coating composition which is formed by steps comprising:
   (i) providing one or more fluorocopolymers by copolymerization of:
      (A) one or more hydrofluoroolefin monomer(s), preferably in an amount of from about 40 mole % to about 70 mole % based on all of the monomers in the copolymer and preferably selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these,
      (B) one or more reactive group substituted, preferably hydroxyl substituted, lower alkyl vinyl ether monomer(s) (and preferably lower alkyl vinyl ethers), preferably in an amount of from about 5 mole % to about 20 mole % based on all of the monomers in the copolymer, and
      (C) one or more of an alkyl vinyl ether monomer(s) (and preferably lower alkyl vinyl ethers) that are not substituted with a reactive group, preferably in an amount of from about 20 mole % to about 40 mole % weight based on all of the monomers in the copolymer, and
      (D) optionally one or more of an alkyl vinyl ester monomer, preferably in an amount of from 0 mole % to about 20 mole % based on all of the monomers in the copolymer,
         wherein the copolymer has a MWn of from about 1000 to about 6000 grams/mole,
   (ii) providing a carrier for said one or more fluorocopolymers; and
   (iii) combining said one or more fluorocopolymers with said carrier to produce a polymeric composition comprising not greater than about 30% by weight of said carrier, preferably with a solids content of at least about 70% by weight;
(c) coating the substrate with said coating composition; and
(d) forming a protective polymeric layer on said substrate by allowing at least a substantial portion of said carrier to evaporate, whereby a protective coating having a 60° gloss of at least about 55, more preferably at least about 60 and even more preferably at least about 70, and a gloss retention of at least about 70%, more preferably at least about 75%, preferably of at least about 80% after 4000 hours.

In preferred embodiments, the fluoropolymer of step (b) is formed by solution copolymerization, emulsion copolymerization and/or dispersion copolymerization of the fluoroolefin and alkyl vinyl ether monomers required by the providing step (b) in either the previous paragraphs. In preferred embodiments, the step of copolymerizing comprises solution copolymerizing:
(1) from about 40 mol % to about 70 mol %, and even more preferably from about 50 mol % to about 70 mol %, and even more preferably from about 55 mol % to about 70 mol % of halooolefin monomer(s), preferably transHFO1234ze; and
(2) from about 20 mol % to 40 mol % of alkyl vinyl ether monomers that do not include a reactive group, more preferably from about 25 mol % to about 35 mol %, and
(3) from about 5 mol % to 20 mol % of alkyl vinyl ether monomers that contain a reactive group, and preferably a hydroxyl group, and more preferably from about 5 mol % to about 15 mol %, with said percentages being based on the total monomers charged to solution copolymerization reaction vessel.

According to a preferred embodiments of the present invention, the co-polymer of the present invention is formed by copolymerization in a reaction medium a combination of monomners consisting essentially of:
(1) transHFO-1234ze in an amount of from about 40 mol % to about 70 mol %, and more preferably from about 50 to about 70 mol %,
(2) from about 20 mol % to about 40 mol % of vinyl ether, more preferably from about 20 mol % to about 30 mol %, represented by formula CH₂═CR³—OR⁴ respectively, wherein R³ is independently either hydrogen or a methyl group and wherein R⁴ is independently selected from the group consisting of a substituted or unsubstituted straight-chain or branched-chain alkyl group having 1 to 5 carbon atoms; and
(3) hydroxyl group-containing vinyl ether monomer(s), preferably in an amount of from about 5 mol % to about 20 mol % of hydroxy vinyl ether monomer, preferably in an amount of from about 5 mol % to about 15 mol %, represented by formula CH₂═C—R⁵—OH, where R⁵ is selected from the group consisting of a C2 to C10 substituted or unsubstituted straight-chain or branched-chain alkyl group, wherein the mol% are based on the total of the monomers in the copolymer formation step.

As used herein, unless otherwise specifically indicated, reference to mol% is to the mol% of monomers used in the formation of the fluorocopolymer of the present invention, based on the total of the monomers

Unless otherwise indicated herein, the number average molecular weight of of a copolymer of the present invention is as measured by gel phase chromatography (“GPC”) according to the method described in Skoog, D. A. Principles of Instrumental Analysis, 6th ed.; Thompson Brooks/Cole: Belmont, Calif., 2006, Chapter 28, which is incorporated herein by reference. The values described herein for molecular weight are based on measurements that use an Agilent-PL gel chromatography column (5 um MIXED-C 300*7.5 mm). The mobile phase is tetrahydrofuran (THF) at a flow rate of 1 ml/minute and a temperature of 35° C. A refractive index detector is used. The unit is calibrated with polystyrene narrow standard available from Agilent.

In certain embodiments, the coating composition formed by step (b) has a VOC content of less than about 450 g/l, more preferably less than about 400 g/l, and even more preferably less than about 300 g/l. The values described herein for VOC are based on measurements made according to ASTM 22369.9963 which covers the standard test method for the determination of the weight percent volatile content of solvent-borne and water-borne coatings. The procedure for calculating the Volatile Organic Compound (VOC) content of a liquid coating is to obtain a sample of the liquid coating to be tested and then weighing the coating in an aluminum foil dish to obtain the weight to the nearest 0.1 mg, which is designated in the following calculations as (W1). Add to the aluminum foil dish 3 ±1 ml of toluene solvent to form the coating specimen. The specimen is then draw into the syringe and the filled syringe is placed on the scale and the scale is tarred. The cap is removed from the syringe and the specimen is dispensed from the syringe into the dish to the target specimen weight (0.3±0.1 g if the expected result is =<40% volatile and 0.5±0.1 g if the expected result is =>40% volatile. The specimen is spread out in the dish to cover the bottom of the dish completely with as uniform thickness as possible. Obtain and record the weight of the specimen to the nearest 0.1 mg, which is designated as the Specimen Weight (SA) in the following calculations. The foil dish containing the specimens is then heated in the forced draft oven for 60 min at 110° C. Each dish is removed from the oven, placed immediately in a desiccator, cooled to ambient temperature, weighed to the nearest 0.1 mg, and this weigh is record, and is indicated as W2 in the following calculations.

To calculate the VOC, V, in the liquid coating, the following equations are used:

VA=1000*DA*(W2−W1)/SA]

### Where:

VA=% volatiles (first determination),
W1=weight of dish,
W2=weight of dish plus specimen
SA=specimen weight,
DA=specimen specific Gravity and
VB=% volatiles (duplicate determination; calculate in same manner as VA).

As used herein, the term “substrate” refers to any device or article, or part of a device or article, to be coated.

As used herein, the term “carrier” is intended to refer to a component of a composition that serves to solvate, disperse and/or emulsify a monomeric or polymeric component of a composition.

### DETAILED DESCRIPTION OF THE INVENTION

As described above, preferred aspects of the present invention involve coating methods that provide reduced VOC emissions while at the same time providing effective and efficient protective coatings on substrates. As those skilled in the art will appreciate, the quality of a protective coating applied to a substrate can be measured by a variety of coating properties that, depending on the particular application, are important for achieving a commercially successful coating on a given substrate. These properties include but are not limited to: (1) viscosity, (2) color retention and (3) substrate adhesion.

Viscosity as used herein is measured according the ASTM Standard Test Method for Measuring Solution Viscosity of Polymers with Differential Viscometer, Designation D5225-14. According to this method as used herein, the viscometer used is a Brookfield viscometer (DV-II+Pro) using spindles S18/S31 using torque values from between 40% and 80% at room temperatures of about 23±2° C. If a solvent is used for the measurements, it is butyl acetate.

The QUV-A is measured as indicated above according to ASTM D 7251, which is QUV Accelerated Weathering Tester Operating Procedure by which accelerated testing is performed in an accelerated testing cabinet sold under the trade mark QUV® manufactured by Q-Lab Corporation of Cleveland Ohio. Two lamps are used in this testing cabinet: “A” lamps (UVA-340) have a normal output of 0.69 W/m²@340 nm m and a maximum output of 1.38 W/m²@340 nm m; and “B” lamps (UVA-313) have a normal output of 0.67 W/m²@310 nm 0.67 and a maximum output of 1.23 W/m²@310 nm m. As used herein, the designation QUV-A refers to tests using the A lamps and QUA-B refers to tests using the B lamps. The procedure is accomplished using the following steps:
1. Measure the initial gloss of the coating film three times and obtain the average of the measurements, which is designated in the following calculations as “A.”
2. Place the test plate containing the coating in the panel holder in the cabinet and power the cabinet on.
3. Set the PROGRAM button in the control panel and select the desired program operation.
4. Engage the RUN button to start test.
5. Record down the exposure time indicated on the led panel
6. Stop the machine after the indicated hours, remove the test plate, and measure the gloss three times to get an average result for the indicated exposure time, and record this value as “B” for use in the calculation below.
7. Determine Gloss retention using the formula Gloss Retention=B/A

In preferred embodiments, the polymers of the present invention have a hydroxyl value of greater than about 70, and in other preferred embodiments have a hydroxyl value of greater than about 90. As mentioned above, the ability to achieve such a method resides, in part, on the judicious selection of the type and the amounts of the various components that are used to form the fluoropolymer and the coating compositions of the present invention.

In preferred embodiments, the polymers of the present invention have a fluorine content of from about 35% to about 50% by weight, or a fluorine content of from about 40% to about 45% by weight.

### MONOMERS

### Hydrofluoroolefins

The hydrofluoroolefin monomers according to the methods of the present invention can include in certain preferred embodiments hydrofluoroethylene monomer, that is, compounds having the formula CX¹X²=CX³X⁴; wherein X′, X², X³, X⁴ are each independently selected from H or F or Cl atom, but at least one of them is a hydrogen atom. Examples of hydrofluoroethylene monomers include, among others:
CH₂═CHF,
CHF═CHF,
CH₂═CF₂, and
CHF═CF₂.

The hydrofluoroolefin monomers according to certain preferred aspects of the methods of the present invention include, and preferably consists essentially of or consist of hydrofluoropropenes having the formula CX⁵X⁶=CX⁷CX⁸X⁹X¹⁰; wherein X⁵, X⁶, X⁷, X⁸, X⁹ and X¹⁰ are independently selected from H or F or Cl atom, but at least one of them is a hydrogen atom and another is a fluorine atom. Examples of hydrofluoro-propene monomers include, among others:
CH₂═CFCF₃ (HFO-1234yf),
trans-CHF═CHCF₃ (trans-HFO-1234ze),
CHCl═CFCF₃ and
CH₂═CHCF₃.

In preferred embodiments, the hydrofluoroolefin comprises, consists essentially of or consist of HFO-1234yf and/or HFO-1234ze. In preferred embodiments, the hydrofluoroolefin comprises, consists essentially of or consist of HFO-1234ze, with said HFO-1234ze preferably comprising, consisting essentially of or consisting of trans- HFO-1234ze.

The hydrofluoroolefin monomers according to certain preferred aspects of the methods of the present invention include, hydrofluorobutene according to the following formula: CX¹¹X¹²=CX¹³CX¹⁴X¹⁵CX¹⁶X¹⁷X¹⁸; wherein X¹¹, X¹², X¹³, X¹⁴, X¹⁵, X¹⁶, X¹⁷ and X¹⁸ are independently selected from H or F or Cl atom, but at least one of them is a hydrogen atom and at least one is a fluorine atom. Examples of hydrofluorobutene include, among others, CF₃CH═CHCF₃.

### Vinyl Esters

The copolymers in accordance with the present invention can optionally include vinyl ester monomer units, preferably in amounts of from greater than 0 mol % to not greater than about 20 mol %. In preferred embodiments the vinyl ester monomer(s) when present are represented by the formula CH₂═CR¹—O(C═O)_{X}R², wherein x is 1 and wherein R¹ is either hydrogen or a methyl group, and wherein R² is selected from the group consisting of a substituted or unsubstituted, preferably unsubstituted, straight-chain or branched-chain, preferably branched chain, alkyl group having 5 to 12 carbon atoms, more preferably having from 5 to 10 carbon atoms, and even more preferably 8 to 10 carbon atoms. In preferred embodiments the alkyl group includes at least one tertiary or quaternary carbon atom. In highly preferred embodiments, the vinyl ester includes at least one quaternary carbon according to the following formula:

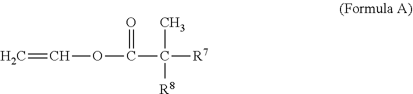

where each of R⁷ and R⁸ are alkyl groups, preferably branched alkyl groups, that together contain from 5 to about 8, more preferably from 6 to 7, carbon atoms.

Examples of vinyl ester monomers that are preferred according to certain preferred embodiments include vinyl acetate, vinyl propionate, vinyl butyrate, vinyl pivalate, vinyl capronate, vinyl laurate, VEOVA-9 (vinyl versatate ester formed from a C9 carbocylic acid, produced by Momentive), VEOVA-10 (vinyl versatate ester formed from a C10 carbocyclic acid, produced by Momentive) and vinyl cyclohexanecarboxylate. Each of VEOVA-9 and VEOVA-10 contain at least one quaternary carbon according to Formula A above. According to preferred embodiments, the vinyl ester comprises vinyl versatate ester having from 11 to 12 carbon atoms in the molecule, preferably with at least one quaternary carbon according to Formula A above.

### Vinyl Ethers

The copolymers in accordance with the present invention preferably are also formed from vinyl ether monomer units, preferably in amounts of from about 20 mol % to about 40 mol %, more preferably from about 25 mol % to about 40 mol. In preferred embodiments the vinyl ester monomer(s) are represented by the formula CH₂═CR³—OR⁴, wherein R³ is independently either hydrogen or a methyl group and wherein R⁴ is selected from the group consisting of a substituted or unsubstituted, preferably unsubstituted, straight-chain or branched-chain, preferably straight chain, alkyl group having 1 to 5 carbon atoms, more preferably 1 to 3 carbon atoms. Examples of vinyl ether monomers that are preferred according to certain preferred embodiments include alkyl vinyl ethers such as methyl vinyl ether, ethyl, propyl vinyl ether, n-butyl vinyl ether, isobutyl vinyl ether, hexyl vinyl ether, octyl vinyl ether, decyl vinyl ether and lauryl vinyl ether. Vinyl ethers including an alicyclic group can also be used, for example, cyclobutyl vinyl ether, cyclopentyl vinyl ether and cyclohexyl vinyl ether. According to preferred embodiments the vinyl ether comprises, consists essentially of, or consists of ethyl vinyl ether.

### Hydroxy Vinyl Ethers

The copolymers in accordance with the present invention preferably are also formed from hydroxyl vinyl ether monomer units, preferably in amounts of from about 3 mol % to about 20 mol % of hydroxy vinyl ether monomer, preferably in an amount of from about 5 mol % to about 15 mol %, more preferably from about 5 mol % to about 10 mol %. In preferred embodiments the hydroxyl vinyl ether monomer(s) are represented by the formula represented by formula CH₂═CR³—O—R⁵—OH, where R³ is as defined above, preferably hydrogen, and where R⁵ is selected from the group consisting of a C2 to C6 substituted or unsubstituted, preferably unsubstituted, straight-chain or branched- chain, preferably straight chain, alkyl group. Examples of preferred hydroxyalkyl vinyl ether monomers include hydroxyl-ethyl vinyl ether, hydroxypropyl vinyl ether, hydroxybutyl vinyl ether, hydroxypentyl vinyl ether and hydroxyhexyl vinyl ether. In certain embodiments, the copolymer is formed from about 5 mol % to about 20 mol % of hydroxyalkyl vinyl ether monomers, based on the total weight of the monomer.

### CoPolymer Formation Methods

It will be appreciated by those skilled in the art, based on the teachings contained herein, that copolymers of the present invention may be formed to achieve the preferred characteristics described herein using a variety of techniques, and all such techniques are within the scope of the present invention.

In preferred embodiments, the fluorocopolymer is preferably produced in a polymerization system that utilizes a carrier for the monomer/polymer during and/or after formation. According to one preferred embodiment the carrier acts as a solvent and/or dispersant for the monomer and/or polymer, and such operations include dispersion, emulsion and solution polymerization. Examples of carriers in such systems, including preferably solvents for solution polymerization, include: esters, such as methyl acetate, ethyl acetate, propyl acetate and butyl acetate; ketones, such as acetone, methyl ethyl acetone and cyclohexanone; aliphatic hydrocarbons, such as hexane, cyclohexane, octane, nonane, decane, undecane, dodecane and mineral spirits; aromatic hydrocarbons, such as benzene, toluene, xylene, naphthalene, and solvent napthta; alcohols, such as methanol, ethanol, tert-butanol, iso-propanol, ethylene glycol monoalkyl ethers; cyclic ethers, such as tetrahydrofuran, tetrahydropyran, and dioxane; fluorinated solvents, such as HCFC-225 and HCFC-141b; dimethyl sulfoxide; and the mixtures thereof.

It is contemplated that the temperature conditions used in the polymerization process of the present invention can be varied according to the particular equipment and applications involved and all such temperatures are within the scope of the present invention. Preferably, the polymerization is conducted at a temperature in a range of from about 30° C. to about 150° C., more preferably from about 40° C. to about 100° C., and even more preferably from about 50° C. to about 70° C., depending on factors such as the polymerization initiation source and type of the polymerization medium.

In certain preferred embodiments, it is preferred that the solution polymerization is conducted under conditions under which the total amount of the solvent used in the copolymerization process, based on the weight of the solvent and monomer in the solution, is from about 10 wt % to about 40 wt %, more preferably in amounts of from about 10 wt % to about 30 wt %, and more preferably in certain embodiments in an amount of from about 15% to about 25%. In certain of such embodiments, the solvent used in the solution copolymerization process comprises, preferably consists essentially of, and more preferably in certain embodiments consists essentially of C2-C5 alkyl acetate, and even more preferably butyl acetate.

In preferred embodiments, the copolymer as formed in accordance with the preferred methods described herein is prepared by copolymerizing those monomers under conditions effective to achieve a copolymer having a number average molecular weight of 5000 to 50,000, or is some embodiments 1000 to 6,000 as measured by gel phase chromatography (“GPC”) according to the method described in Skoog, D. A. Principles of Instrumental Analysis, 6th ed.; Thompson Brooks/Cole: Belmont, Calif., 2006, Chapter 28, which is incorporated herein by reference. In certain embodiments, the copolymer has a number average molecular weight that is greater than about 6,000, and even more preferably from 4,000 to about 6,000. According to certain preferred embodiments, the copolymer has a molecular weight distribution of 1.5 to about 3, more preferably 1.9 to about 3, and most preferably 1.9 to about 2.5. Applicants have found that in certain embodiments the use of copolymers having a molecular weight properties as disclosed herein with and exceptional and unexpected ability to provide high solid content, low viscosity coating compositions that also unexpectedly possess desirable levels of gloss and gloss durability.

### Coating Composition Formation Methods

The copolymers as formed in accordance with the procedures described herein may then be used to form various coating compositions that have the substantial advantages described above. For example, various solvents can be used for the preparation of solution-type paints or coatings by adding those solvents to the fluorocopolymer of the present invention formed as described herein. In certain embodiments, preferred solvents for formation of the coating composition include aromatic hydrocarbons such as xylene and toluene; alcohols such as n-butanol; esters such as butyl acetate; ketones such as methyl isobutyl ketone, and glycol ethers such as ethyl cellusolve and various commercial thinners.

In certain embodiments, the coating composition of the present invention has a solid content of from about 70% to about 90% by weight based on the total weight of the coating composition, and more preferably in certain embodiments from about 75% go about 85% by weight of solids. In certain preferred embodiments, the solids comprise and preferably consist essentially of the copolymers of the present invention and/or cross-linked copolymers formed using the copolymers of the present invention. Although it is contemplated that those skilled in the art will be able to form coatings using the present compositions according to anyone of known methods, in preferred embodiment the coating is formed by brushing, a rolling, air spraying, airless spraying, flow coating, roller coating, a spin coating, and the like and any combination of these may be used. Furthermore, the coating can be applied on various substrates. The coating film can be formed directly on a substrate or via a primer or if necessary, via an undercoating layer. Although all thicknesses are within the scope of the present invention, in preferred embodiments the outermost cured coating film layer has a layer thickness of from about 20 to about 30 μm.

### EXAMPLES

### Example 1—Fluoropolymer Preparation

A solution polymerization operation is carried out by charging into a 1 liter stainless steel autoclave equipped with a stirrer the components as indicated in the following Table 1 in accordance with the procedure descried thereafter:

TABLE 1

| COMPONENT | | Weight, |
|---|---|---|
| TYPE | NAME | grams |
| Solvent | butyl acetate | 54 |
| Hydrohaloolefin | trans-1,3,3,3- | 287 |
| Monomer | tetrafluoropropene | |
| | (trans-HFO-1234ze) | |
| Alkyl vinyl ether | EVA | 85 |
| monomer | | |
| | HBVE | 50 |
| Catalyst | Zinc oxide (ZnO) | 25 |
| Initiator | tertbutylperoxypivalate | 20 |
| Chain transfer | Methanol | 80 |

The ZnO was added to the autoclave, and then the autoclave vacuumed and sealed. The butyl acetate, EVE and HBVE were then charged into the autoclave. Then, the trans-HFO-1234ze were added in the reaction mixture in the autoclave, and the autoclave was gradually heated to about 87° C. with agitation of about 400 revolutions per minute (rpm). When the temperature reached 87° C., the tert-butyl peroxypivalate was added into the autoclave and 20 g of methanol was fed into the autoclave during the course of the next 1 hour, and then the remaining 60.0 g methanol was added into the autoclave and the temperature was increased from 87° C. to 130° C. and then the autoclave was maintained at 130° C. for 3 hrs. The autoclave was then cooled to room temperature, the unreacted monomers were purged, and the autoclave was opened. Excess solvent was removed via evaporation and a polymer solution with 80 wt % solid content and a viscosity of 3,600 cps was obtained. The final fluorocopolymer (without solvent) was tested and found to have: a number average molecular weight (Mn) of about 4,500 and a Mw/Mn of 1.89; a hydroxyl value of 90 mg KOH/g; a Fluorine content of 44 wt %. The yield of cofluoropolymer was about 87%.

The result reported in Example 1 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

### Example 2—Fluoropolymer Preparation

A solution polymerization operation is carried out by charging into a 1 liter stainless steel autoclave equipped with a stirrer the components as indicated in the following Table 2 in accordance with the procedure descried thereafter:

TABLE 2

| COMPONENT | | Weight, |
|---|---|---|
| TYPE | NAME | grams |
| Solvent | butyl acetate | 110 |
| Hydrohaloolefin | trans-1,3,3,3- | 287 |
| Monomer | tetrafluoropropene | |
| | (trans-HFO-1234ze) | |
| Alkyl vinyl ether | EVA | 100 |
| monomer | | |
| | HBVE | 40 |
| Catalyst | Zinc oxide (ZnO) | 25 |
| Initiator | Tertbutyl peroxypivalate | 20 |
| Chain transfer | Methanol | 30 |

The ZnO was added to the autoclave, and then the autoclave vacuumed and sealed. The butyl acetate, EVE and HBVE were then charged into the autoclave. Then, the trans-HFO-1234ze were added in the reaction mixture in the autoclave, and the autoclave was gradually heated to about 87° C. with agitation of about 400 revolutions per minute (rpm). When the temperature reached 87° C., the tert-butyl peroxypivalate was added into the autoclave. After being maintained for 3 hours at 87° C., the methanol was added into the autoclave and the temperature was increased from 87° C. to 130° C. After the autoclave reached 130° C., it was maintained at this temperature for 3 hours. The autoclave was cooled to room temperature, the unreacted monomers were purged, and the autoclave was opened. Excess solvent was removed via evaporation and a polymer solution with 80 wt % solid content and a viscosity of 7,600 cps was obtained. The final fluorocopolymer (without solvent) was tested and found to have: a number average molecular weight (Mn) of about 5,300 and a Mw/Mn of 2.24; a hydroxyl value of 90 mg KOH/g; a Fluorine content of 43 wt %. The yield of cofluoropolymer was about 89%.

The ZnO The result reported in Example 2 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

### Example 3—Fluoropolymer Preparation

A solution polymerization operation is carried out by charging into a 1 liter stainless steel autoclave equipped with a stirrer the components as indicated in the following Table 3 in accordance with the procedure descried thereafter:

TABLE 3

| COMPONENT | | Weight, |
|---|---|---|
| TYPE | NAME | grams |
| Solvent | butyl acetate | 110 |
| Hydrohaloolefin | trans-1,3,3,3- | 287 |
| Monomer | tetrafluoropropene | |
| | (trans-HFO-1234ze) | |
| Alkyl vinyl ether | EVA | 100 |
| monomer | | |
| | HBVE | 40 |
| Catalyst | Zinc oxide (ZnO) | 25 |
| Initiator | Tertbutyl peroxypivalate | 20 |
| Chain transfer | Methanol | 30 |

The ZnO was added to the autoclave, and then the autoclave vacuumed and sealed. The butyl acetate, EVE and HBVE were then charged into the autoclave. Then, the trans-HFO-1234ze were added in the reaction mixture in the autoclave, and the autoclave was gradually heated to about 87° C. with agitation of about 400 revolutions per minute (rpm). When the temperature reached 87° C., the tert-butyl peroxypivalate was added into the autoclave. After being maintained for 3 hours at 87° C., the methanol was added into the autoclave and the temperature was increased from 87° C. to 150° C. After the autoclave reached 150° C., it was maintained at this temperature for 3 hours. The autoclave was cooled to room temperature, the unreacted monomers were purged, and the autoclave was opened. Excess solvent was removed via evaporation and a polymer solution with 80 wt % solid content and a viscosity of 9,600 cps was obtained. The final fluorocopolymer (without solvent) was tested and found to have: a number average molecular weight (Mn) of about 4,600 and a Mw/Mn of 2.13; a hydroxyl value of 65 mg KOH/g; a Fluorine content of 44 wt %. The yield of cofluoropolymer was about 93%.

### Example 4—Coating Composition and Coating Properties

A coating composition in the form of a white paste is formed using the polymer composition formed in Example 1 hereof. The white paste is formed by adding 310.9 grams of copolymer composition formed in Example 1 hereof, and the other ingredients identified in Table 4 below in the amounts indicated, into a 1,500 ml can. 300 grams of glass beads are then added as grinding medium into the can and the contents are milled at 3000 rpm for 1 hour or until the fines reaches 10 um.

TABLE 4A
White Paste

| COMPONENT | | Weight, |
|---|---|---|
| TYPE | NAME | grams |
| Resin | Example 1 copolymer | 310.9 |
| | (80% solids and | |
| | viscosity of 3600 cPs) | |
| Pigment | Titanium oxide | 500 |
| | (Ti-Pure R960) | |
| Dispersant | BYK 180 | 10 |
| Solvent | butyl acetate | 58.4 |

The glass beads are removed from the white paste so produced, and then the white paste without the glass beads is introduced, together with curing agent and other additives, into a new can, and stirred at 1500 rpm for about 15 minutes or until a uniform solution is achieved. This pigment paste is combined with additional resin as indicated in Table 4B below to produce the Let Down (Main Package).

TABLE 4B
Let Down (Main Package)

| COMPONENT | | Parts by |
|---|---|---|
| TYPE | NAME | weight |
| Pigment paste | Example 4 white paste | 73.4 |
| | as per above | |
| Additional resin | Example 1 copolymer | 26.6 |
| | (80% solids and | |
| | viscosity of 3600 cPs) | |
| Solvent | butyl acetate | 0 |
| Total | | 100 |
| Solids (%) | | 84.5 |

A series of samples formed by taking a portion of the material as formed in this Example in Table 4B a diluting the sample with butyl acetate to the solids content as indicated in Table 4C below and the viscosity of each sample is measured by Sheen Ref. 480 (expressed as KU in the table):

TABLE 4C

| Sample # | Solids | KU |
|---|---|---|
| 1 | 83% | 118.2 |
| 2 | 80% | 86.4 |
| 3 | 78% | 70.1 |
| 4 | 76% | 62.8 |
| 5 | 73% | 59.5 |
| 6 | 71% | 56.7 |

A commercial fluorocoplymer product based on fluroethylene/vinyl ether is tested using the same viscosity versus solids content test described in connection with Table 4C, and the results of this test are reported in Example 4D below:

TABLE 4D

FEVE

| Sample | Solids | KU |
|---|---|---|
| 1 | 75% | 106.1 |
| 2 | 73% | 88.1 |
| 3 | 71% | 77.0 |
| 4 | 69% | 69.0 |
| 5 | 67% | 63.9 |
| 6 | 65% | 61.0 |
| 7 | 63% | 57.9 |
| 8 | 61% | 55.8 |
| 9 | 60% | 53.6 |
| 10 | 58% | 52.7 |
| 11 | 57% | 51.3 |

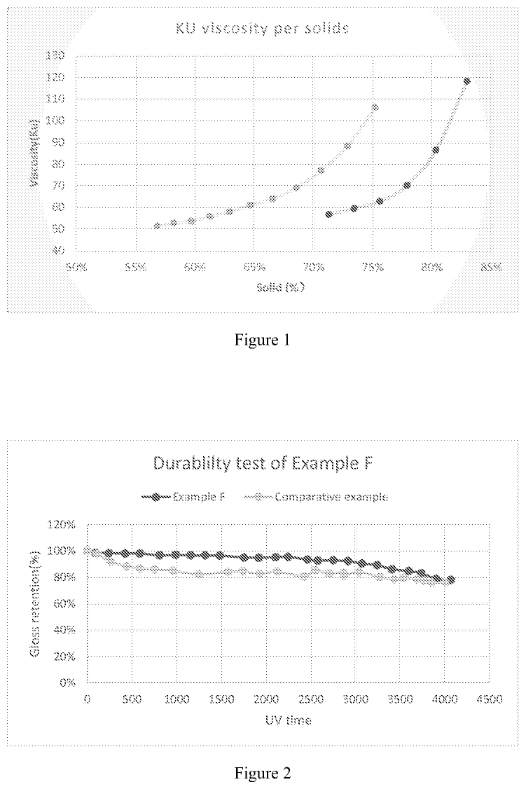

The viscosity results are reported herein are illustrated in FIG. 1 hereof. As can be seen from these results and as illustrated in FIG. 1, the present invention provides copolymers, coating compositions and coating methods which have the advantage of providing a high solids content at a much lower viscosity than competitive materials. As those skilled in the art will appreciate, this is an unexpected by highly important advantage.

In addition, the coatings of the present invention are capable of being formed with very low VOC levels. In particular, the density and solids are determined for the Let-Down material using each of 20S (using T-4 cup viscosity, which is used for viscosity in air pressure spraying) and using 70 KU (which is used for viscosity in airless spraying), and based on this information the VOCs (volatile organic compounds) are calculated using the equation VOCs=1000*(1-Solids) *density (unit being g/L), and this information is provided in Table 4E below:

TABLE 4E

| | VOC |
|---|---|
| 1 (20 s), g/L | 430 |
| 2 (70 KU), g/L | 360 |

In addition, an equivalent curing agent (—NCO:—OH=1.05:1) is added into the Let Down of Table 4B to form a white paint, and this white paint is then applied to a hot dipped galvanized steel (HDG) substrate. The thickness of the substrate was about 0.3 mm. The substrate was sanded by 400 mesh sandpaper. The coated panel was placed in oven set at a temperature of about 80° C. for 24 hours, which produces a fully cured dry film topcoat. The dry film thickness of the topcoat was about 35±5 um and was found to have the properties in Table 4F below:

TABLE 4F

| Property | Test Method | | Results |
|---|---|---|---|
| Gloss | ASTM D 523 | 60° | 72.3 |
| Pencil hardness | ASTM D 3363 | Scratch | HB |
| Flexibility | GB/T 6742 | 2 mm | pass |
| Dry adhesion | ASTM D 3359 | Cross-hatch | 5B |
| Acid resistance | GB/T 9274 | 5% H₂SO₄*10 | No blistering, |
| | | days | no color change |

The UV exposure conditions are provided in Table 4G below:

TABLE 4G

| | Typical | Approximate | |
|---|---|---|---|
| Lamp | Irradiance | Wavelength | Exposure Cycle |
| UVB- | 0.49 | 310 nm | 8 h UV at 70 (±3) ° C. |
| 313 | W/m2/nm | | Black Panel Temperature; |
| | | | 4 h Condensation at 50 (±3) |
| | | | ° C. Black Panel Temperature |

The results of this durability performance test are illustrated in FIG. 2 and show that the present invention is able to provide a highly durable coating having a initial durability of about 100% and remaining at about 100% after about 1500 hours and decreasing only slightly and remaining at about 90% or greater up to about 3000 hours. This results are illustrated in FIG. 2, together with the results from a competitive material which shows a durability that declines much more rapidly than the paint according to the present invention.

### Example 5—Coating Composition and Coating Properties

Example 4 is repeated except that the copolymer produced in Example 2 is used instead of the copolymer of Example 1. Similar advantageous and unexpected results are achieved.

### Example 6—Coating Composition and Coating Properties

Example 4 is repeated except that the copolymer produced in Example 3 is used instead of the copolymer of Example 1. Similar advantageous and unexpected results are achieved.

1. A fluorocopolymer formed by copolymerization of:
(1) one or more hydrofluoroolefin monomer(s) in an amount of from about 40 mole % to about 70 mole % based on all of the monomers in the copolymer
(2) one or more of an alkyl vinyl ether monomer(s) that are not substituted with a reactive group in an amount of from about 20 mole % to about 40 mole % weight based on all of the monomers in the copolymer,
(3) one or more reactive group substituted, lower alkyl vinyl ether monomer(s) in an amount of from about 5 mole % to about 20 mole % based on all of the monomers in the copolymer, and
(4) optionally one or more of an alkyl vinyl ester monomer in an amount, when present, of not greater than about 20 mole % based on all of the monomers in the copolymer,
wherein the copolymer has a MWn of from about 1000 to about 6000 grams/mole.

2. The fluorocopolymer of claim 1 wherein said one or more hydrofluoroolefin monomer(s) is selected from the group consisting of hydrofluoroethylenes, hydrofluoropropenes, hydrofluorobutenes, hydrofluoropentenes and combinations of these.

3. The fluorocopolymer of claim 1 wherein said one or more hydrofluoroolefin monomer(s) is selected from 2,3,3,3-tetrafluoropropene and 1,3,3,3-tetrafluoropropene.

4. The fluorocopolymer of claim 3 wherein said one or more hydrofluoroolefin monomer(s) consists essentially of trans-,3,3,3-tetrafluoropropene.

5. The fluorocopolymer of claim 1 wherein said one or more of an alkyl vinyl ether monomer(s) that are not substituted with a reactive group consist essentially of lower alkyl vinyl ethers.

6. The fluorocopolymer of claim 4 wherein said one or more of an alkyl vinyl ether monomer(s) that are not substituted with a reactive group consist essentially of lower alkyl vinyl ethers.

7. The fluorocopolymer of claim 1 wherein said one or more of a reactive group substituted, lower alkyl vinyl ether monomer(s) comprises a hydroxyl substituted lower alkyl vinyl ether.

8. The fluorocopolymer of claim 6 wherein said one or more of a reactive group substituted, lower alkyl vinyl ether monomer(s) comprises a hydroxyl substituted lower alkyl vinyl ether.

9. The fluorocopolymer of claim 1 having a hydroxyl value of from about 50 to about 150 a viscosity of from about 4000 mPas to about 12000 mPas at an 80% solids content in butyl acetate.

10. A coating composition comprising a carrier and a fluorocopolymer of claim 1.
